(19) United States
(12) Patent Application Publication
(10) Pub. No.: US 2026/0008060 A1
(43) Pub. Date: Jan. 8, 2026

(54) FEED DEVICE AND ROLLER FACILITY

(71) Applicant: Swisca AG, Appenzell (CH)

(72) Inventors: Adrian Schaffer, Appenzell (CH); Bruno Fässler, Appenzell (CH)

(21) Appl. No.: 18/992,637

(22) PCT Filed: Jul. 11, 2023
(86) PCT No.: PCT/EP2023/069203

§ 371 Date: Jan. 9, 2025

(30) Foreign Application Priority Data
Jul. 12, 2022 (CH) CH000830/2022

(51) Int. Cl. B02C 4/28; B02C 4/02

(52) U.S. Cl. CPC B02C 4/286; B02C 4/02

(57) ABSTRACT

A feed device for a roller facility for processing foodstuff includes a collection space into which processing material can be fed via an infeed. A feed roller serves for conveying processing material, which is present in the collection space, away out of the collection space. For this purpose the feed roller is arranged at the lower side on the collection space and is rotatable about an axis. The feed device above the feed roller includes a first conveying device for conveying the processing material in the collection space in the axial direction. A second conveying device is provided for conveying processing material which is conveyed by the first conveying device, in a direction which is different from the conveying direction of the first conveying device. By way of this, a particularly uniform distribution of the processing material along the axis of the feed roller is ensured.

### BACKGROUND OF THE INVENTION

### Field of the Invention

The invention relates to a feed device for a roller facility for foodstuff processing, for example a roller mill or a flaking mill, as well as to a roller facility with a feed device.

### Description of Related Art

Roller mills according to the state of the art often have a centrally arranged inlet for the grinding material which is to be ground. The grinding material accumulates in a collection space and from there, conveyed by a feed roller, gets into the grinding space where it is reduced in size between grinding rollers. The axis of the feed roller is herein generally parallel to the axes of the grinding rollers and the collection space extends in a longitudinal direction over the complete length of the feed roller.

A distribution of the collected grinding material over the length of the feed roller is effected according to the state of the art on the one hand for example by the gravitational force, by way of the collection space being large enough for a bulk material cone to be able to form, the width of which corresponding to the length of the feed roller. The technical development entails the roller mills having longer and longer grinding rollers and consequently also longer and longer feed rollers being manufactured. For this reason, the inlet must be designed higher and higher in order to ensure an adequately wide bulk material cone. This however has its limits, which is why the gravimetric distribution sooner or later is no longer sufficient on exceeding a certain roller length—depending on the nature of the grinding material which defines the angle of the bulk material cone.

For this reason, the solution of actively conveying the grinding material outwards above the feed roller by way of a conveying shaft is known from the state of the art. The conveying shaft is driven by a drive of the feed roller. In order to be able to accommodate the different nature of the grinding material, the paddles of such conveying shafts which are designed as paddle shafts have an adjustable paddle angle. By way of this solution, the feed device can also be suitable for larger roller mills with grinding rollers of a length of more than one metre and/or for products which do not flow so well. However, the solution has the disadvantage that an adjustment of the paddles is only possible given an empty collection space when the operation is interrupted. Moreover, in practise, it is very difficult to find the optimal setting. For this reason, one must also accept the fact that the distribution is not completely uniform over the length of the feed roller, but that the feed roller conveys less grinding material at the outer ends, or that grinding material accumulates at the end of the conveying shaft, which given time entails the risk of machine defects or the permanent unhygienic adhesion of the grinding material. If different products with different flow characteristics are to be ground, then the feed device moreover needs to be reset again and again. In practise, this is hardly done, which is why the feed device is often operated in a non-optimised mode, with a non-uniform distribution of the grinding material over the length of the rollers. A further disadvantage of the solutions according to the state of the art is the fact that paddle shafts with adjustable paddles are potentially unhygienic, since they include open threads and screws in the collection space, thus are in direct contact with the milled product.

For this reason, a feed device is suggested in EP 3 572 151, concerning which the grinding material inlet as well as a first filling level sensor is attached to one end of the feed roller and of the conveying shaft, and a second filling level sensor is attached to the other end of the feed roller and of the conveying shaft. According to this solution, the speed of the conveying shaft is designed such that it can be closed-loop controlled independently of that of the feed roller. This solution is to ensure that the feed roller is always supplied with grinding material over its entire length. However, it necessities a relative extensive sensor system and a rather complicated closed-loop control and has a delicate dependence on the perfect functioning of the filling level sensors; given malfunctions accumulated grinding material at the other end must leave the collections space through the feed gap. On dealing with a malfunction, there is the danger of no product being brought out in sections over a short period of time. Moreover, given a malfunction, a compressing of the grinding material at the end of the conveying shaft can occur. Due to the lateral grinding material inlet, the feed device on installation moreover necessitates adaptations of existing cereal mills since such mills are generally conceived for roller mills with a centrally arranged inlet.

A further subject in the context of roller mills and their feed devices is aspiration. Generally, an overpressure prevails in the collection space due to the fact that air also flows in together with the grinding material. If this pressure is not reduced, then this leads to the escape from the collection space; moreover air can flow out of the collection space into the feed gap. For this reason and also for the reduction of dust and humidity, it has been suggested to suck air out of the collection space via a connection which is specially provided for this. According to the first approach (external aspiration), this is effected by way of the connection of a separate air pipe with its own fan. This creates an additional expense and entails a larger installation effort (pipe construction).

A further possibility envisages the connection of a suction location at the collection space through a suitable tube to the pneumatic conveying conduit. The pneumatic conveying conduit-which is often present in any case-serves for conveying away the grinding material after passage through the grinding gap and after collection by a funnel (trimelle). The connection to the pneumatic conveying conduit avoids the necessity of providing a separate aspiration system or, if such is present in any case for other milling facility machines, permits a smaller dimensioning of this aspiration system and avoids an addition pipe construction. However, it necessitates an additional pipe which is difficultly accessible for cleaning and maintenance, and is likewise relatively cumbersome.

According to a further approach (internal aspiration), it has been suggested to attach a-correspondingly shorter-pipe between a lateral location in the collection space above the feed roller and the grinding space, in order to permit a pressure equalisation. Concerning this solution, the airflow can draw fine particles into the pipe, since the airflow is led past at the level of the grinding material and the pipe inherent of its design attaches close to this level. This can lead to deposits on the pipe even to the extent of a blockage.

### SUMMARY OF THE INVENTION

It is the object of the present invention to provide a feed device for roller facilities for foodstuff processing, as well as such a roller facility, in particular a roller mill, which overcomes the disadvantages of the state of the art. A further object is the provision of a uniform, well controllable feed of processing material into the processing space (for example grinding space) with the processing rollers (for example grinding rollers), wherein the feed is to be reliable even given the different nature of processing material. A further object is the provision of a solution for the problem of aspiration.

These objects are achieved by the invention as is defined in the patent claims.

According to a first aspect of the invention, a feed device for a roller facility for the processing of foodstuff is provided. This includes a collection space, into which a processing material can be fed via an inlet. A feed roller serves for conveying the processing material which is present in the collections space away out of the collection space. For this purpose, the feed roller is arranged on the connection space at the lower side and is rotatable about an axis. On account of its rotation, it carries along the processing material with it and conveys it, in particular through a feed gap whose width can be adjusted in a manner known per se, for example by way of an adjustable slide. Above the feed roller, the feed device includes a (first) conveying device for conveying the processing material in the collection space in the axial direction (“axial” relates to the axis of the feed roller) towards at least one end side. It is characterised by a second conveying device for conveying processing material which is conveyed by the first conveying device, in another direction away from the end side.

In particular, the second conveying device can be configured for conveying the processing material which is conveyed by the first conveying device, in an axial direction which is opposite to the axial direction (in which the first conveying device conveys).

In the present text a “processing material” generally describes a foodstuff product, in particular a cereal product, which is present as bulk material and which is to be processed in a roller facility. If the roller facility is a roller mill, then the processing material is a grinding material. If the roller facility is a flaking mill, then the processing material is formed by cereal grains or groats or wholemeal which is to be flaked.

The second conveying device is therefore arranged such that it conveys processing material away from the end side, and specifically within the collection space. No conveyed material can build up at the end side, but processing material which is possibly conveyed in excess towards the end side gets back into a region from where it can be captured by the feed roller or by the first conveying shaft.

The second conveying device in particular conveys processing material which is conveyed by the first conveying device, back in the direction from whence it comes. If the feed device includes a central inlet into the collection space, then the conveying by the first conveying device takes place in the axial direction towards the sides, outwards away from the centre. The second conveying device-depending on the set conveying speed of the first conveying device-then conveys shares of the outwardly conveyed processing material back inwards again.

Given a non-central infeed laterally on the collection space, the first conveying device conveys the processing material away from the side with the infeed towards the other end side, and the second conveying device for example conveys processing material back in the direction towards the side with the infeed-likewise depending on the set conveying speed of the first conveying device.

It is also possible for the second conveying device to convey the processing material from the end sides or from the end side upwards, from wherein it falls down again past the second conveying device on account of the action of gravity, wherein at least shares of the upwardly conveyed processing material are likewise moved back in the direction from whence they came. With this variant too, on the one hand an accumulation and compressing of the processing material at the end sides or the end side is prevented, and likewise a certain transport back in the direction from whence the processing material comes is likewise effected.

The initially outlined problem is solved by the second conveying device. The first conveying device can be operated with a delivery rate which at all events, even given changing characteristics of the processing material and independently of the presence of air pockets of the like, can be sufficient in order to reliably convey processing material up to the outer ends (given a central infeed) or up to the opposite end (given a lateral infeed). The conveying speed can be dependent for example only on the rotation speed of the feed roller, which automatically results if—which can be one option—the first conveying device is driven by the same drive as the feed roller. The first conveying device can therefore in particular be operated with an on average slightly too highly set delivery rate and therefore conveys somewhat more processing material than is actually necessary. The second conveying device then ensures that the processing material which is possibly conveyed in excess does not build up and compact at the end side, but is conveyed back and sooner or later is distributed along the axis of the feed roller. For this reason, the distribution along the axis of the feed roller is rendered very robust and reliable by way of this approach.

A further advantage of the approach according to the first aspect of the invention lies in the feed device on starting being able to be operated with conveying and return conveying over a longer time, until the collection space is optimally filled and intermixed. This is not possible with feed devices according to the state of the art.

The second conveying device is arranged such that in particular it conveys shares of the processing material which are conveyed in excess. The second conveying device can be arranged for example above the first conveying device, i.e. vertically above it in a direct manner or with an also horizontally offset, for example parallel conveying axis. The second conveying device however can also lie at a different position, for example next to the first conveying device, depending on the geometry of the collection space.

The first conveying device in particular can be designed as a conveying shaft. Such is particularly suitable for the use in an environment which is partly filled by processing material since both ends can be easily sealed to the outside and the shaft as a whole includes no regions which should not be covered by the processing material. Such a conveying shaft generally has a shaft core (“web”) with helical conveying structures which are present thereon. Such structures can be formed by discrete paddles or alternatively by a continuous worm thread. In the latter case, there is also the possibility of the shaft also being formed without a shaft core, as a so-called “shaftless” worm conveyor.

The second conveying device can also be a conveying shaft which is arranged for example horizontally, thus with the axis parallel to the axis of the feed roller. The same advantages result as for the first conveying shaft. The second conveying device can also be formed by two conveying shafts which are separate from one another, each at the two end sides, in the case of a centrally arranged infeed. In particular, in this case the conveying axes of the second conveying device can also be at an angle to the axial direction, for example obliquely or even vertically upwards.

Alternative conveying devices are for example running belts or rollers, for example belts or rollers which run at the front and/or rear at the delimitation of the collection space, with conveying structures which project inwards into the collection space. Other alternative conveying devices are likewise not ruled out, for example as an option for the second conveying device, the use of compressed air, by way of which the processing material is blown back inwards to above the first conveying device from the end sides or the end side.

Given a central infeed, at least the second conveying device can be free of conveying structures in a central region below the infeed. On the one hand such conveying structures are not necessary at all in the central region due to the dynamics which are present in the collection space, and on the other hand an undesirable compacting of processing material shares which are conveyed in the opposite direction is rendered impossible in the middle.

There is also the option of the second conveying device—for example if it is designed as a horizontal (second) conveying shaft—to be provided with mixing structures in the region below the infeed, the mixing structures mechanically processing the processing material which comes into contact with them, without systematically conveying in the one or the other direction. Herewith, an advantage of the procedure according to the invention—especially with a “narrow” inlet as is discussed in this text—is increased yet further. The combination of a—for example powerful—first conveying device with the second conveying device specifically can efficiently prevent a de-mixing on feeding different processing material constituents through different infeed pipe stubs. The additional mixing structures yet further amplify this positive effect.

Such mixing structures in particular can project radially outwards from the shaft core and protrude from this. For example, they can be formed by radially running rods, or also by mixing bars—bars or plates which extend parallel to the axis.

In particular, if the second conveying device is a horizontal (second) conveying shaft, it can be sufficient if the structures for conveying away from the end side/end sides at the second conveying shaft—for example paddles or a continuous worm thread—are only present in the proximity of the end side(s). This leaves sufficient space for such mixing structures in a central region between the end sides.

Mixing structures of the described type efficiently counteract a bridge formation given especially poorly flowing and/or sticky grinding material, additionally yet mix the infeed product, ensure that the bulk product angle is smaller and as a whole have a positive influence on the product flow by way of them preventing zones with a stagnant product. In particular, if they are designed as mixing bars, they also effect a somewhat greater power uptake which is why they can be present in particular as an option and can be reversibly releasably fastened to the second conveying shaft, so that they can be removed if required, depending on the grinding material.

Supplementarily or alternatively to the mixing structures on the second conveying device, mixing structures on the first conveying device can also be an option. These can likewise be arranged below the infeed.

If the conveying devices are designed as conveying shafts with a shaft core, then in contrast to solutions according to the state of the art, the conveying structures—for example paddles—can be fixedly connected, for example welded, to the shaft core. This results from the fact that on account of the approach according to the first aspect of the invention, a mechanical setting of the conveying characteristics becomes superfluous. The outlined problems regarding hygiene in the case of open threads and screws in the collection space can therefore be solved in an elegant manner.

In a group of embodiments, at least the first conveying device includes an individual conveying device drive which is independent of the drive of the feed roller. In contrast to conveying shafts according to the state of the art which are driven by a belt drive which is fixedly connected to the drive of the feed roller, the conveying speed of the conveying device(s) can thus be adjusted independently of the feed roller, and specifically also during the operation.

The feed device thus in particular can be designed such that a setting of the delivery rate by the first conveying device and for example also by the second conveying device is possible without emptying the collection space.

An independent drive for example includes its own electric motor which is separate from the electric motor of the feed roller drive.

The independent conveying device drive can include a single electric motor which drives the first conveying device and possibly also the second conveying device, for example via belts, cogs or other elements. It can also include an electric motor each for the first and the second conveying device.

The feature of the independent conveying device drive in combination with the optional features of the fixed connection between the conveying shaft core and conveying structures is particularly advantageous.

In a group of embodiments, the feed device is of the type “narrow inlet” which means that the collection space in an upper region is designed in the manner of a chamber which is open to the bottom towards the conveying devices, with a peripheral wall. The width (the extension in the axial direction) is herein significantly smaller than the axial length of the feed roller and of the conveying devices. The “axial length” of the feed roller and of the conveying devices, inasmuch as is not expressly stated otherwise, is always the extension in the inside of the collection space, without the shares of the roller or shafts (or other means) which penetrate the delimitation of the collection space and serve for mounting as well as attachment of the drive.

In the present text, the region which is chamber-like—in embodiments it can also be essentially box-like with a rectangular outline—is denoted as the “upper part-collection-space”. The region with the conveying device or the conveying devices which extends downwards to the feed roller and whose width corresponds to the length of the feed roller and of the conveying device(s) is accordingly denoted as the “lower part-collection-space”. The lower part-collection-space connects at the bottom to the upper part-collection-space and apart from a front and rear delimitation (wall and/or doors, each possibly with windows) and lateral delimitations also includes an upper delimitation laterally of the upper part-collection-space. This upper delimitation can be essentially horizontal or it can be inclined slightly to the horizontal, for example by an inclination angle of maximally 10°, maximally 7° or maximally 5°.

Embodiments of this type amongst other things have the advantage that in comparison to feed devices with a wide collection space to the top, a simpler and improved control of the filling quantity in the collection space is possible. Moreover, the intermixing of different processing material is improved in comparison to feed devices with a wide bulk material cone. On the downside, the controllability of the filling level as well as the reliable transport of the processing material along the complete length of the feed roller tends to be more demanding than given a wide collection space, which is why the procedure according to the invention, specifically with an independent drive of the conveying devices, is particularly suitable for such embodiments.

The maximal width of the upper part-collection-space (width, i.e. axial extension of the inner volume) results from the available space, as is commonly present in cereal mills, as well as from the subsequently discussed requirement of the collection space having to be sealed to the bottom by the processing material in normal operation, so that the operation can be easily closed-loop controlled. The width—measured at the widest location of the upper part-collection-space—can be for example 50 cm at the most, 45 cm at the most or 40 cm at the most. As a rule, at all events it will be smaller than half the axial length of the feed roller.

The peripheral wall of the upper part-collection-space can be inclined vertically or at least in regions can be inclined slightly to the vertical, for example with a maximal inclination angle of 10°, 7° or 5°.

According to a second aspect of the present invention which in particular can be combined particularly well with the first aspect, a roller facility, for example a roller mill, with a feed device of this type with an upper part-collection-space and a lower part-collection-space includes at least one aspiration channel between the upper part-collection-space and the processing space with the processing rollers. The aspiration channel is a gas-leading conduit which can include a cross section which is round, rectangular or one which is shaped in another manner and which does not need to be constant along the channel. In particular, one or more aspiration channels can be led along the peripheral wall of the upper part-collection-space and from there further downwards into the processing space, for example along the rear wall of the lower part-collection-space.

The at least one aspiration channel in embodiments can end in particular above the pair of processing rollers. The solution with the aspiration channel which connects the upper part-collection-space to the processing space above the process rollers can be particularly favourable: if the aspiration channel were to end below the pair of processing rollers, the pressure resistance would at most be too high. If the aspiration channel begins below the upper part-collection-space, there is the danger of blockage.

The aspiration channel ensures that during operation, air continuously goes from the infeed and the upper part-collection-space, where an overpressure prevails, to the processing space in which an underpressure exists due to the vacuuming and pneumatic conveying of the processing material. Thus, an internal aspirating takes place. Firstly, a blockage of the aspiration channel can be prevented very efficiently by way of the upper part-collection-space being connected to the processing space. Secondly, by way of this, during operation it is always ensured that air and fine processing material which is entrained by this does not flow along any paths past the feed roller from the collection space into the processing space to a significant extent.

The approach according to the second aspect of the invention, under certain circumstances also permits the system to be closed off given closed doors (for example the grinding space door; possibly doors into the collection space). By way of this, one also prevents moisture or spores etc. from getting into the region with the processing material in an uncontrolled manner.

The roller facility according to the second aspect in particular is operated such that the processing material always seals off the upper part-collection-spec to the bottom, i.e. the processing material in normal operation always assumes the complete cross-sectional area in the upper part-collection-space at least at the very bottom. For this reason, air cannot flow through the feed gap or possible unsealed locations, for example at the sides, past the slide from the collection space into the processing space to a significant extent and entrain processing material in an uncontrolled manner. The at least one aspiration channel according to the second aspect of the inventions takes this circumstance into account without having to accept the disadvantages of the external aspiration.

As is known per se—and as an option with all aspects of the present invention—the feed devices of the roller facility can include a filling level monitoring. The filling level which is determined by this—i.e. the level of the processing material in the collection space—can be included in the control, in order to control the rotation speed of the feed roller and/or the delivery rate of the conveying device(s). Supplementarily or alternatively, the filling level can also serve for the controlling the quantity of fed processing material via an inlet slide, an inlet flap or another metering device.

According to a further, third aspect of the present invention which can be combined particularly well with the first and/or second aspect, a feed device with a narrow inlet, which is to say with an upper part-collection-space with a peripheral wall and a lower part-collection-space with at least one conveying device (for example with two conveying devices if the feed device also corresponds to the first aspect), includes a viewing window which is not only present on the peripheral wall of the upper part-collection-space, but also extends downwards into a covering of the lower part-collection-space. The viewing window has a width which is larger than the width of the upper part-collection-space.

The viewing window can extend axially up to close to the end sides of the lower part-collection-space. “Close to the end sides” in the present context means that the ends of the conveying device(s) which extend through the lower part-collection-space are well visible through the viewing window, which for example can mean that the viewing window extends on both sides up to the end sides, or ends laterally at a distance of at the most approx. 10 cm from the end sides.

The viewing window can be continuous or subdivided. A possible subdivision however should not prevent all regions of the collection space being able to be seen down to the lower limit of the viewing window.

The viewing window which in contrast to the state of the art not only renders viewable the narrow region below the infeed (the upper part-collection-space) but also the region with the conveying device or the conveying devices, permits a visual assessment of the product distribution, the product quality and the product intermixing in the feed device. Due to the viewing window extending from the upper part-collection-space to the lower part-collection-space, it permits a good assessment of the product flow through the feed device. Possible malfunctioning, contamination, mould formation etc. can be seen through the viewing window without the operation having to be interrupted and the collection space opened. The viewing window can be able to be folded open so that the collection space is simply accessible in the case of a malfunction, contamination, setting-in mould formation or the like is ascertained.

According to all aspects of the present invention, the roller facility in the form of a roller mill can also be designed as a multiple roller mill, with a plurality of pairs of grinding rollers, wherein the two pairs are arranged in a successive manner and can therefore be at least roughly at the same height. In embodiments of the second and/or third aspect of the invention, as well as generally in embodiments with a “narrow” inlet according to the definition which is used here, the roller mill can be designed such that the upper part-collection-space is free of transport pipes which lead through it. Possibly present transport pipes can be led between the pairs of grinding rollers and between the feed rollers which are assigned to these, as well as between conveying devices, laterally of the upper part-collection-space (which can be subdivided into two compartments, each for the front and the rear grinding roller pair). Such an arrangement, for typical diameters of transport pipes of for example approx. 90-100 mm is also possible for the shortest common roller length of 1000 mm and for in total up to four transport pipes which are arranged next to one another and lead through the roller mill, if the width of the upper part-collection-space including possible aspiration channels which run laterally thereto is not more than approx. 55 cm, which is very well compatible with the dimensions for the width of the upper part-collection-space which have been discussed above.

### BRIEF DESCRIPTION OF THE DRAWINGS

Embodiments of the invention are hereinafter described by way of drawings. In the drawings, the same reference numerals denote equal or analogous elements. The drawings are all schematic and not true to scale. They show elements which partly correspond to one another, in sizes which differ from figure to figure. There are shown:

FIG. 1 a representation of a feed device;

FIG. 2 a cross-sectional representation of the feed device of FIG. 1;

FIG. 3 a representation of an alternative feed device;

FIG. 4 the feed device according to FIG. 3, together with transport pipes as well as with a drawn-in filling level of the processing material,

FIG. 5 a schematic diagram with the control;

FIG. 6 a roller mill with an aspiration channel;

FIG. 7 a view from above a double roller mill with a narrow inlet;

FIG. 8 a construction with conveying devices with additional mixing structures;

FIG. 9-17 alternative possibilities for the design of the second conveying device;

FIG. 18 a cross-sectional representation of an alternative design of the second conveying device, which is analogous to FIG. 2; and

FIG. 19 schematically, a first and a second conveying device with mixing bars.

### DETAILED DESCRIPTION OF THE INVENTION

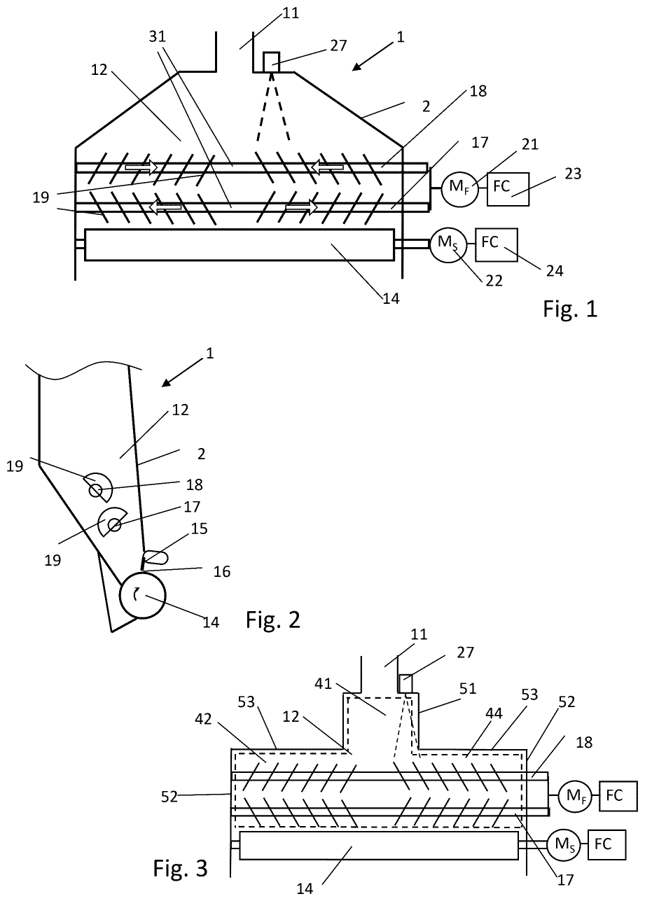

FIGS. 1 and 2 show a feed device 1 according to a first embodiment. The feed device at the upper side includes an infeed 11 which is only schematically represented in FIG. 1 and a collection space 12 which is formed by a housing 2. The collection space 12 is closed to the bottom by a feed roller 14 which interacts with an adjustable slide 15, in order to convey the processing material in the collection space through a feed slot 16, so that it gets into the processing space (grinding space) where it is reduced in size between the grinding rollers.

The infeed 11 is located centrally (with respect to the axial directions) above the feed roller 14 and the conveying shafts 17, 18 which are yet described in more detail hereinafter. As is known per se, the feed can include one or more pipe stubs, onto which conduits with the fed processing material can be coupled.

On account of the central arrangement of the infeed, the processing material needs to be distributed outwards in an axial direction for a uniform distribution in the grinding gap (not drawn in FIGS. 1 and 2). Up to a certain degree, this is effected by way of the accumulation of a processing material cone below the infeed 11. However, this generally is not sufficient, which is why the processing material is actively conveyed in the axial direction for an improved axial distribution.

For this purpose, the feed device includes a first conveying device, specifically a first conveying shaft 17 for conveying the processing material outwards in the axial direction, thus from a central region 31 below the feed in two opposite directions, as is indicated by the double arrows. For this purpose, paddles 19—or other conveying structures, for example structures which at least in regions run in a helical manner—are arranged in two outer regions, each in an oppositely orientated, i.e. for example mirrored manner.

Moreover, the feed device includes a second conveying device, specifically a second conveying shaft 18 for conveying the processing material in the opposite axial direction, thus back inwards. The second conveying shaft 18 is arranged above the first conveying shaft, so that it is mainly the shares of the processing material which would otherwise accumulate from the ends of the first conveying shaft 17, thus axially outwards, which are captured by it. In the shown example, the second conveying shaft 18, although being arranged above the first conveying shaft 17 is however also slightly horizontally offset, and specifically to the rear (see FIG. 2). Such a slightly offset arrangement has the advantage that the vertical distance between the conveying shafts can be somewhat smaller than is the case given an arrangement of the two conveying shafts directly vertically above one another. A reduced vertical distance which for example is a little smaller than the sum of the radii of the paddles 19 can be advantageous, since herewith a lateral accumulation of processing material can be prevented particularly well.

In order for the processing material to be conveyed by the second conveying shaft 18 in an axial direction opposite to the first conveying shaft, the conveying structures (paddles 19) as indicated in FIG. 1 can be attached in a converse manner in comparison to the first conveying shaft 17, this in a mirrored manner. Alternatively, it would also be possible to design the second conveying shaft equally to the first conveying shaft, but to let it rotate in the opposite direction.

Paddles 19 as are present as conveying structures on both conveying shafts 17, 18 are known per se. Given a rotation movement of the respective conveying shaft, they transport the processing material in the envisaged direction by way of them pushing it in front of them or, depending on the rotation speed, imparting an impulse upon them in the envisaged conveying direction. The paddles 19—or other conveying structures which for example run helically in regions, for example worm thread—can be fixedly welded to the actual shaft or fastened to it in another manner, which overcomes the initially described problems of hygiene.

The upper conveying shaft 18 and in the drawn embodiment also the lower conveying shaft 17 includes a central region 31 without paddles 19. Therefore, no conveying of processing material takes place in this central region.

Moreover, FIG. 1 illustrates the possibility of the conveying shafts 17, 18 including a conveying shaft drive 21 which is independent of the feed roller drive 22 by way of it having its own electric motor. This has the already mentioned advantage that the speed of the conveying shafts 17, 18 can be set independently of the speed of the feed roller and can also be changed during the operation. In the represented embodiment example, the first conveying shaft 17 and the second conveying shaft are coupled to one another or to the conveying shaft drive 21, such that driven by the conveying shaft drive 21 they always rotate with a fixed speed ratio, for example of 1:1 (i.e. at the same speed).

Alternatively, it is also possible for the conveying shafts to be driven by the drive of the feed roller for example via suitable belts. Conversely, one also cannot rule out the first conveying shaft 17 and the second conveying shaft 18 each having their own drive and their rotation speeds being able to be set independently.

FIG. 1 also illustrates the conveying shaft supply unit 23 separately from the feed roller supply unit 24; in reality the supply units can optionally also be integrated into a common electronics unit.

The feed device further includes a filling level monitoring which in the represented embodiment example is formed by a radar sensor 27 as is taught in the Swiss patent application 448/2022 of 14.4.2022. Another filling level monitoring which determines the filling level for example by way of a capacitive sensor, a weight measurement and/or optically and/or in another manner are likewise an option.

FIG. 3 illustrates an alternative embodiment which differs from that of FIGS. 1 and 2 by the shape of the collection space 12. The collection space 12 is subdivided into a chamber-like upper part-collection-space 41 with a peripheral, approximately vertical wall 51 and into a lower part-collection-space 42 which extends along the complete length of the feed roller. The upper part-collection-space can have the shape of a box with a roughly rectangular outline or also have a roughly circular or slightly elliptical outline. At the upper side, the infeed 11 in the form of at least one conduit—generally it is several, for example four conduits, for which the housing 2 each includes a connection stub or the like—runs out into the upper part-collection-space 41. The width (axial extension) of the upper part-collection-space is significantly smaller than the axial extension of the feed roller 14. By way of this, the lower part-collection-space 42, apart from a front-side and rear-side delimitation as well as lateral delimitations 52, also includes a horizontal upper delimitation 53 which is located laterally of the first part-collection-space 41 and under certain circumstances is also situated in front of and/or behind the upper part-collection-space.

A viewing window 44 which is indicated by a peripherally dashed line is arranged and dimensioned such that it is not only present on the peripheral wall 51 of the upper part-collection-space, but also extends downwards into the cover of the lower part-collection-space 42, so that at least the upper conveying shaft 18 is visible through the window. The viewing window can be vertical or roughly vertical at least in sections.

The viewing window extends axially up to close to the end sides of the lower part-collection-space, i.e. essentially up to positions which correspond to the axial ends of the conveying shafts 17, 18 and of the feed roller 14 (expressed more precisely: the axial ends of that portion of the conveying shafts/feed roller which come into contact with the processing material).

In particular, with embodiments with a comparatively narrow upper part-collection-space 41 as is drawn in FIG. 3 and in the subsequent figures, a conveying shaft drive 23 which is independent of the feed roller drive 22 is particularly advantageous. Specifically, it has been found that it is particularly with these embodiments that the best results can be achieved if the speed ratio of the feed roller and the conveying shaft(s) is not constant, but can be adapted to the processing material and possibly other parameters.

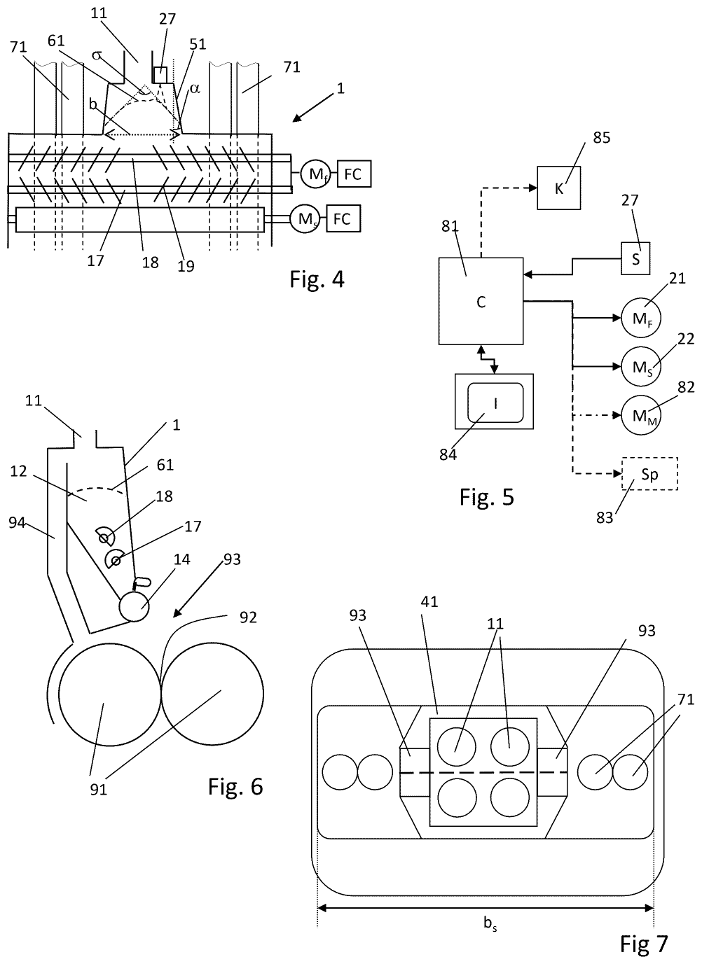

FIG. 4 illustrates further optional features of a feed device with an upper part-collection-space 41 and a lower part-collection-space 42 with at least one conveying shaft 17, 18. In FIG. 4, the viewing window is not indicated for representative reasons, but a viewing window with the aforedescribed characteristics is also considered an option for devices with the features which are described by way of FIG. 4.

Firstly, FIG. 4 shows that the peripheral wall of the chamber which forms the upper part-collection-space 41 does not necessarily need to be vertical but can be slightly inclined to the vertical. The inclination angle α of at least one part of the peripheral wall, i.e. one of the side wall, the front or rear wall in particular can be between 0° and a few degrees, for example can be between 0° (vertical) and 10°, in particular between 0° and 7° or between 0° and 5°. Given a rectangular outline, in particular at least one wall—or two walls which lie opposite one another, for example as is illustrated in FIG. 4 the two lateral walls or also the front wall and the rear wall can be inclined to the vertical. A slight inclination of at least one region of the peripheral wall can be advantageous in order to prevent so-called processing material bridges, due to which larger air inclusions can form in the inside of the processing material—even if these are general not any problem on account of the active processing material conveying by the conveying devices.

Secondly, FIG. 4 illustrates transport pipes 71 which lead through the roller mill 71. Such serve for the transport of processing material or other goods between devices and/or storage locations of the cereal mill and it is not an absolute necessity for them to be connected to the respective roller mill. For example, transport pipes can transport the processing material away, for example pneumatically, after the passage through the roller mill.

Roller mills are often manufactured as multiple roller mills (four-roller mills or also with roller pairs which are arranged above one another as eight-roller mills). Concerning such, for reasons of space it is often necessary for transport pipes to be led through the roller mill—independently of whether the transport pipes serve for leading away processing material out of the respective roller mill or only for connecting other elements of the cereal mill to one another. Since the collection space extends further to the rear in the upper region (see FIG. 2 in which the front side lies at the right in the figure), according to the state of the art one often needs to find a solution in which the transport pipes are led themselves through the collection space or these must be restricted by notches or the like for the transport pipes. Regards design, this is often unsatisfactory. Measures which are discussed in the present text permit embodiments concerning which transport pipes are arranged in the axial direction next to the upper part-collection-space 41 and thus do not affect the collection space.

In particular, the width of the upper part-collection-space 41 can be selected such that even given a smallest roller length of 1 m, there is still space at both sides each for two infeed pipes with a pipe diameter of for example each 95 mm, which is why the width b of the upper part-collection-space at the very bottom is for example maximally approx. 550 mm, for example maximally approx. 500 mm and in particular without possible aspiration channels which are led laterally past the actual upper part-collection-space 41, maximally approx. 450 mm.

Thirdly, FIG. 4 illustrates the principle of the processing material constantly sealing off the volume in the upper part-collection-space to the bottom by way of the processing material in the upper part-collection-space at least at the very bottom always assuming the completer cross-sectional area. For this purpose, the feed device or the facility into which the roller facility with the feed device is embedded is configured to accordingly continuously closed-loop control the filling level 61 of the processing material on operation. The opening angle σ of the bulk material cone varies depending on the processing material and has a value between 90° and 120°. The control (see FIG. 5) of the feed device is therefore configured for example to set the filling level in the upper part-collection-space 41 such that the sealing is always ensured given the steepest bulk material cone (σ=90°) and also given a certain lateral offset of the bulk material cone, wherein the maximal lateral offset up to which the sealing is ensured, can be for example up to 30 mm, up to 50 mm or even up to 100 mm. For typical desired filling levels, this can result in the criterion of the width b of the upper part-collection-space 41 being maximally 500 mm, in particular maximally approx. 450 mm.

FIG. 5 illustrates the control 81 which can correspond to the control of the complete roller mill (this analogously applies to another roller facility) and which can be integrated into the control of a complete facility or be connected to this via suitable communication channels. The control obtains signals of the radar sensor 27—and/or of one or more other sensors for detecting the filling level—and controls the conveying shaft drive 21 and the feed roller drive 22 and under certain circumstances also has an influence on the flow of the fed processing material, which is represented in FIG. 5 as an optional control of an inlet slide 85. In embodiments, the control is effected with the comparatively narrow upper part-collection-space 41 such that the condition described above, according to which the processing material always seals the volume towards the infeed to the bottom is fulfilled, for which the separate conveying shaft drive 21 is advantageous. In particular, on integration into the control of the roller mill, the speed of the grinding rollers can also be controlled accordingly (grinding roller drive 82). A user interface 84 permits the input and/or output of information and commands by and to a user respectively, for example a manual influence on the speeds of the feed roller and/or the conveying shafts. FIG. 5 yet also illustrates the option of adjusting the feed gap in a motorised and controlled manner (feed gap setting 83 via the adjustable slide 15), wherein in many embodiments the setting of the feed gap is effected mechanically and given a standstill of the feed device, wherein however a feed gap adjustment during operation can also be possible.

Given an automatic setting of the rotation speeds of the conveying shafts and/or of the feed roller in dependence on a filling level which is measured by the radar sensor 27, the sensor, the control and the drives of the conveying shafts and/or of the feed roller form a closed-loop control circuit with the filling level of the processing material as a—for example adjustable—setpoint.

FIG. 6 shows a roller mill as an example of a roller facility and apart from the feed device 1 also shows a grinding space 93 with pair of grinding rollers 91, between which the grinding gap 92 is formed, into which grinding gap the processing material which is conveyed by the feed roller 14 goes. In the represented example, at least one aspiration channel 94 exists between an upper region of the upper part-collection-space 41 above the filling level 61 and the grinding space 93, in particular the region above the grinding rollers 91. Such an aspiration channel can be led along the rear side of the collection space 12 as is drawn in FIG. 6. Supplementarily or alternatively, aspiration channels which are led laterally along the upper part-collection-space and for example at the rear side along the lower conveying device are also considered.

FIG. 7 very schematically illustrates a top view of a double roller mill with a “narrow” inlet, i.e. with a feed device of the type which is sketched in FIGS. 3 and 4. The infeed 11 includes connections for four pipes. An aspiration channel 93 runs along the lateral walls of the upper part-collection-space each on both sides next to the upper part-collection-space 41. The dashed line represents a subdivision between the front and rear compartment of the upper part-collection-space, by which means the processing material is already divided in the upper part-collection-space between share for the front grinding roller pair (for example the lower half of the roller mill in FIG. 7) and for the rear grinding roller pair (for example in the upper half of the roller mill in FIG. 7). The aspiration channels run below the upper part-collection-space between the lower part-collection-spaces for the two grinding roller pairs and the assigned feed rollers and conveying shafts. The transport pipes 71 which do not necessarily belong to the roller mill also run between the lower part-collection-spaces for the two grinding roller pairs and the assigned feed rollers and conveying shafts.

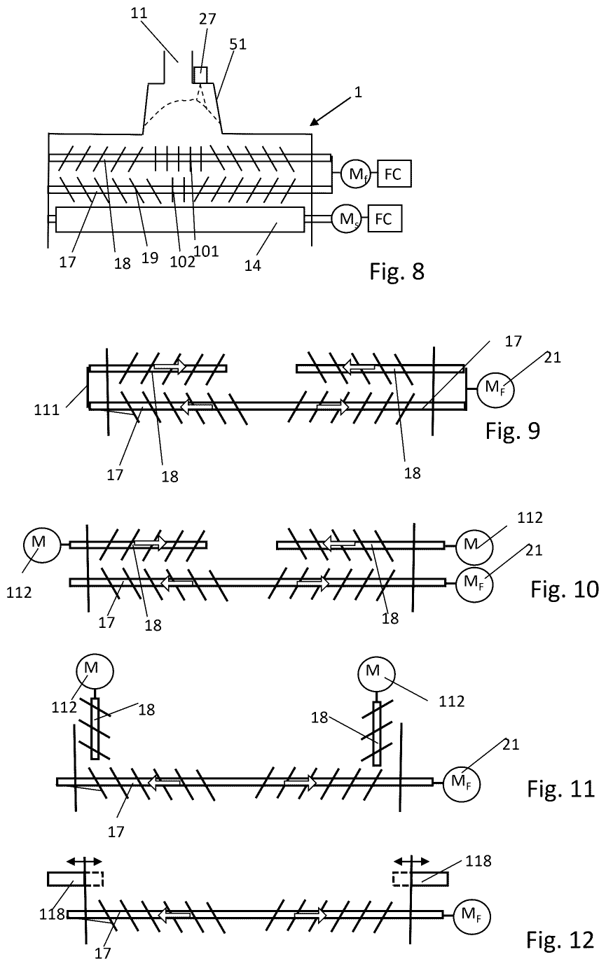

The possibility of providing the second conveying device—here the second conveying shaft 18—with mixing structures, i.e. structures which move the processing material and mix it without systematically conveying it in the one or the other axial direction is schematically illustrated in FIG. 8. The mixing structures can be formed for example by way of rods which coming from the shaft core project outwards, or by any other structures which are suitable for the mixing process. These mixing structures are present in a central region below the infeed. The same possibility also exists for the first conveying device (first conveying shaft 17).

Hereinafter, possibilities as to how the second conveying device could be designed as an alternative to a single-part shaft with a shaft core and with oppositely arranged conveying structures towards both sides as has been sketched in the above examples, are hereinafter sketched very schematically by way of FIG. 9-17.

According to FIG. 9, the second conveying device can be of several parts, specifically in FIG. 9 of two parts, each with a second conveying shaft on both sides, wherein the second conveying device is interrupted in the region below the feed. In FIG. 9, the drive is effected by the conveying shaft drive 21—with the aid of suitable transmission means, for example at least one belt.

However, it is also possible, given a solution as is sketched in FIG. 9, for the second conveying shafts 18 to each include its own drive 112, as is sketched in FIG. 10.

FIG. 11 illustrates the possibility of the second conveying shaft or the second conveying shafts 18 not running axially but at an angle to the axis of the feed roller and of the first conveying shaft. In FIG. 11, the second conveying shafts are vertical so that they convey processing material which is conveyed onto the end sides, upwards, from where it can laterally drop down again and again be captured by the first conveying shaft or is transferred through the feed gap and at all events cannot accumulate at the end side.

FIG. 12 schematically shows the possibility of the second conveying means not being formed by a conveying shaft, but by a periodically moving plunger 118 which presses accumulating processing material inwards.

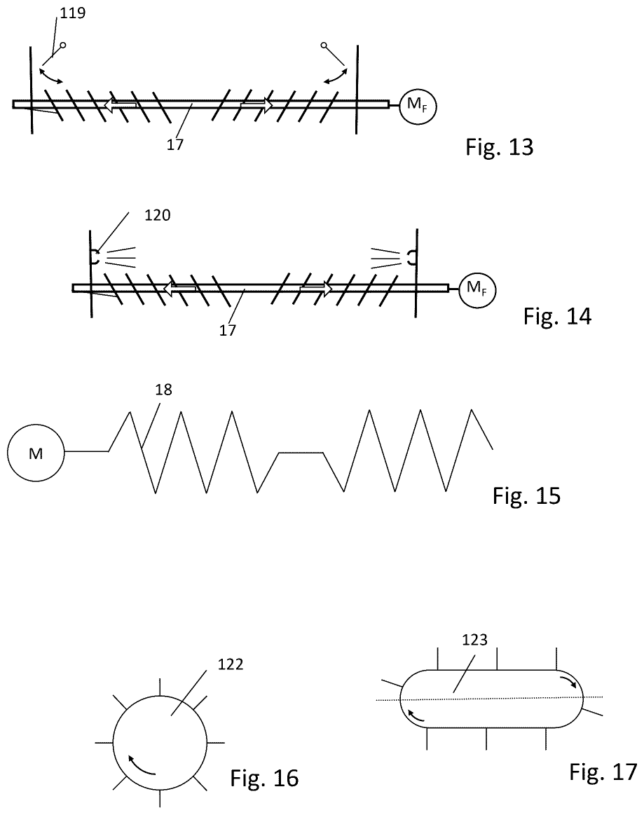

FIG. 13 as a further possibility shows a second conveying means in the form of a pivot plate 119 which likewise moves accumulating processing material.

According to FIG. 14 the second conveying means uses a compressed air nozzle which blows inwards the processing material which accumulates at the end side.

FIG. 15 very schematically illustrates the possibility of the second conveying means although being present as a second conveying shaft 18, however not being present above (and/or laterally) of the first conveying shaft, but as a “shaftless” (or “core-less”) worm conveyor which in its inside can receive the first conveying shaft—i.e. the worm conveyor can be roughly coaxial to the first conveying shaft.

FIG. 16 likewise very schematically shows a roller 122 with conveying structures which can be arranged vertically or horizontally, in order to convey processing material which has accumulated at the end side, away from the end side.

FIG. 17 illustrates a revolving belt with conveying structures which can be arranged for example such that at the one side (for example above the dotted line in FIG. 17) it engages into the region above the first conveying device, whereas it runs back in a region (in the example below the dotted line in FIG. 17) in which there is no contact with the processing material.

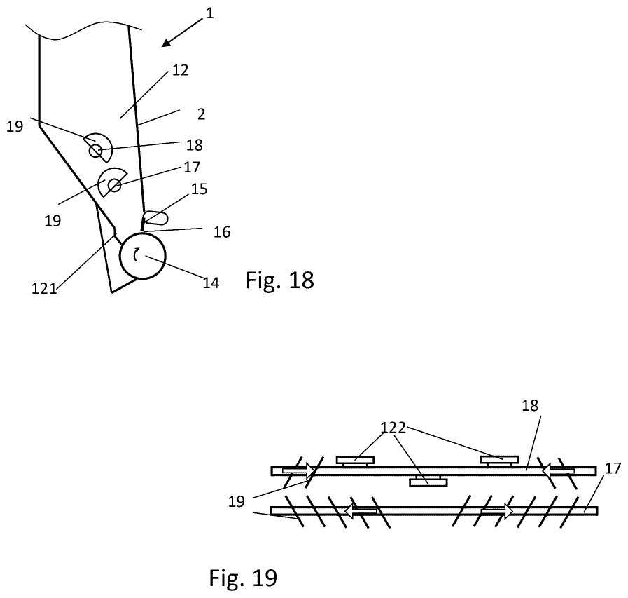

FIG. 18 shows a design of the collection space 12 which differs from the design according to FIG. 2 in that the rearward wall of the collection space forms a shoulder 121 at the narrowest location—directly above the feed roller. This shoulder 121—in the form of a vertically running wall section of the otherwise oblique rear wall—efficiently counteracts a bridge formation given poorly flowing grinding material.

FIG. 19 finally illustrates the principle of mixing bars 122 on the second conveying shaft 18. In FIG. 19 one can also see that the paddles 19, i.e. the structures for conveying away from the end sides are arranged on the second conveying shaft only at the very outer side, which depending on the constellation can be sufficient in order to achieve the effect which is discussed in this text.

As an alternative to the drawn embodiments, all aspects of the invention can also be realised if the feed is not attached centrally, but laterally.

1. A feed device for a roller facility for foodstuff processing, comprising a collection space into which a processing material can be fed via an infeed, and a feed roller with an axis, wherein the feed roller is arranged on the collection space at the lower side, and wherein processing material which is present in the collection space can be conveyed away out of the collection space by the feed roller, wherein the feed device furthermore above the feed roller comprises a first conveying device for conveying the processing material in the collection space in the axial direction towards at least one end side, characterised by a second conveying device for conveying processing material which is conveyed by the first conveying device, away from the end side

2. The feed device according to claim 1, wherein the second conveying device is configured for conveying the processing material which is conveyed by the first conveying device, in a direction opposite to the axial direction.

3. The feed device according to claim 1, wherein the second conveying device is arranged above the first conveying device.

4. The feed device according to claim 1, wherein the first conveying device is formed by a first conveying shaft and the second conveying device is formed by a second conveying shaft.

5. The feed device according to claim 4, wherein the first conveying shaft and/or the second conveying shaft comprises a shaft core as well as paddles which are fixedly connected to the shaft core.

6. The feed device according to claim 4, wherein the first conveying shaft and the second conveying shaft are coupled to one another and/or onto a common conveying shaft drive, such that they rotate with a fixed rotation speed ratio.

7. The feed device according to claim 4, wherein at least the second conveying shaft in a region below the infeed is free of paddles and other conveying structures.

8. The feed device according to claim 4, wherein the first conveying shaft and the second conveying shaft each comprise a first and a second outer region with conveying structures, wherein the conveying structures of the first and second outer region convey in opposite directions.

9. The feed device according to claim 4, wherein the first conveying shaft and/or the second conveying shaft in a region below the infeed comprises mixing structures for the active intermixing of the processing material.

10. The feed device according to claim 1, wherein the first and the second conveying device comprise a conveying device drive which is independent of a drive of the feed roller.

11. The feed device according to claim 10, wherein a delivery rate of at least the first conveying device can be adjusted.

12. The feed device according to claim 1, wherein the collection space comprises a lower part-collection-space and an upper part-collection-space, wherein the upper part-collection-space is formed by a downwardly open chamber with a peripheral wall and at the lower side runs into the lower part-collection-space, wherein an extension of the chamber in the axial direction is smaller than an axial extension of the feed roller and of the conveying devices.

13. The feed device according to claim 12, wherein the collection space comprises a viewing window which extends downwards at least to the lower part-collection-space.

14. A roller facility comprising at least one processing space with at least one pair of processing rollers, between which a processing material can be reduced in size and/or flaked, as well as a feed device according to claim 1, which is arranged such that processing material which is conveyed by the feed roller gets into the processing space.

15. The roller facility according to claim 14, comprising a gas-leading aspiration channel between an upper region of the collection space and the processing space.

16. A roller facility, comprising a feed device with a collection space as well as a processing space with at least one pair of processing rollers, between which a processing material can be reduced in size and/or flaked, wherein the collection space comprises a lower part-collection-space and an upper part-collection-space, wherein the upper part-collection-space is formed by a downwardly open chamber with a peripheral wall and at the lower side runs out into the lower part-collection-space, wherein an extension of the upper part-collection-space in the axial direction is smaller than an axial extension of the feed roller, wherein processing material can be fed to the upper part-collection-space via an infeed, wherein the feed device further comprises a feed roller with an axis, wherein the feed roller is arranged at the lower side on the lower part-collection-space, wherein processing material which is present in the lower part-collection-space can be conveyed out of the lower collection space into the processing space by the feed roller, and wherein the feed device further comprises a first conveying device for conveying the processing material in the lower part-collection-space in the axial direction, characterised in that the roller facility further comprises at least one gas-leading aspiration channel between the upper part-collection-space and the processing space.

17. The roller facility according to claim 16, comprising a control which is configured to operate the feed roller and the at least one conveying device such that the processing material constantly seals the infeed towards the lower part-collection-space.

18. The roller facility according to claim 17, comprising a filling level monitoring for determining a filling level in the collection space, wherein the control is configured to take into account the determined filling level on setting a processing material quantity which gets through the infeed into the collection space and/or a rotation speed of the feed roller and/or a delivery rate of the first conveying device.

19. The roller facility according to claim 16, wherein the collection space comprises a viewing window which extends downwards at least to the lower part-collection-space.

20. The roller facility according to claim 16, wherein the aspiration channel or at least one of the aspiration channels is led laterally or at the rear side along the upper part-collection-space and at the rear side along the lower part-collection-space and ends above the pair of processing rollers.
